(19) United States
(12) Patent Application Publication
(10) Pub. No.: US 2006/0008737 A1
(43) Pub. Date: Jan. 12, 2006

(54) Method of using a formed body

(76) Inventors: Carol L. Cole, Manassas Park, VA (US); Brian M. Burn, Annandale, VA (US); Timothy M. Hsieh, Potomac, MD (US); Jonathan A. Hack, Gainesville, FL (US)

Correspondence Address: Tim M. Hsieh, Esq., 9322 Glen Road, Potomac, MD, 20854, US

(21) Appl. No.: 11/176,257

(22) Filed: Jul. 8, 2005

Related U.S. Application Data
(60) Provisional application No. 60/586,412, filed on Jul. 9, 2004.

(51) Int. Cl. G03C 1/492

(52) U.S. Cl. 430/270.1

(57) ABSTRACT

A method for slowing the degradation of a polymeric container, the method including forming the polymeric container from a composition including a plurality of nanoparticles dispersed therein.

### DESCRIPTION OF THE DISCLOSURE

This disclosure claims the priority benefit of U.S. Provisional Application Ser. No. 60/586,412, filed on Jul. 9, 2005, which is incorporated herein by reference in its entirety.

### FIELD OF THE DISCLOSURE

The subject matter of this application relates to amethod for slowing the degradation of a polymeric container, said method comprising forming the polymeric container from a composition comprising a plurality of nanoparticles dispersed therein.

### BACKGROUND OF THE DISCLOSURE

Many consumer products sold in bottles or containers are susceptible to degradation by UV radiation. For example, medicines easily break down and become ineffective or dangerous when exposed to UV radiation such as that present in natural sunlight. For that reason, medicine is typically sold in opaque containers or brownish or yellowish translucent containers. These containers, however, make it difficult to determine the contents of the container without opening them.

Similarly, food stuffs such as, for example, dairy products, beer, wine, juice, soda, etc., degrade when exposed to UV radiation, thereby losing their nutritional value and taste. Many cooking oils and salad oils are now offered in clear PET [poly(ethylene terephthalate)] packaging. Practically all vegetable or seed-based oils such as soybean, olive, safflower, cottonseed and corn oils contain varying levels of unsaturated olefinic acids or esters (e.g. linoleates) which are susceptible to light-induced degradation. Most plant based oils also contain natural chlorophyll or other pigment photosensitizers. Milk is packaged in translucent or white pigmented HDPE bottles to reduce the amount of light transmission through the plastic. It is well known that beer is normally bottled in amber or green-tinted glass to protect it from light.

UV absorbers in adhesive compositions suitable for use as an adhesive layer in a laminated article or multi-layer construction are discussed. The laminated articles include solar control films, films and glazings, UV absorbing glasses and glass coatings, optical films and the like are also discussed. The protection of interior structures, textiles and fabrics from UV induced photodegradation such as in automotive applications is discussed. The description, preparation and uses of the s-triazine UV absorbers are described for automotive coatings, photographic application, polymeric film coatings and ink jet printing.

### SUMMARY OF THE DISCLOSURE

According to one embodiment, there is provided a method for slowing the degradation of a polymeric container, said method comprising forming the polymeric container from a composition comprising a plurality of nanoparticles dispersed therein.

According to another embodiment, there is provided a method for radiantly conducting ultraviolet radiation impinging upon a useful article, said method comprising forming the article from at least one material comprising a plurality of nanoparticles.

According to another embodiment, there is provided a method for attenuating the passage of ultraviolet radiation through a container designed to hold at least one consumable product, said method comprising forming the container from a composition comprising a plurality of nanoparticles.

Additional objects and advantages of the disclosure will be set forth in part in the description which follows, and in part will be obvious from the description, or may be learned by practice of the disclosure. The objects and advantages of the disclosure may be realized and attained by means of the elements and combinations, such as those pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate at least one embodiment of the disclosure and together with the description, serve to explain the principles of the disclosure.

### BRIEF DESCRIPTION OF THE DRAWINGS

FIG. 1 depicts a container.

FIG. 2A depicts a plurality of nanoparticles dispersed in a material.

FIG. 2B depicts a plurality of coated nanoparticles in a material.

### DESCRIPTION OF THE EMBODIMENTS

Reference will now be made in detail to the present exemplary embodiments of the disclosure, an example of which is illustrated in the accompanying drawings. Wherever possible, the same reference numbers will be used throughout the drawings to refer to the same or like parts.

UV radiation may be understood by one of ordinary skill in the art as radiation having a wavelength of about 250 to about 460 nanometers (nm). For example, UVA wavelengths may be generally in the range of from about 320 to about 400 nm, UVB wavelengths may be in the range from about 290 to about 320 nm, and UVC wavelengths may range below about 290 nm, down to about 250 nm.

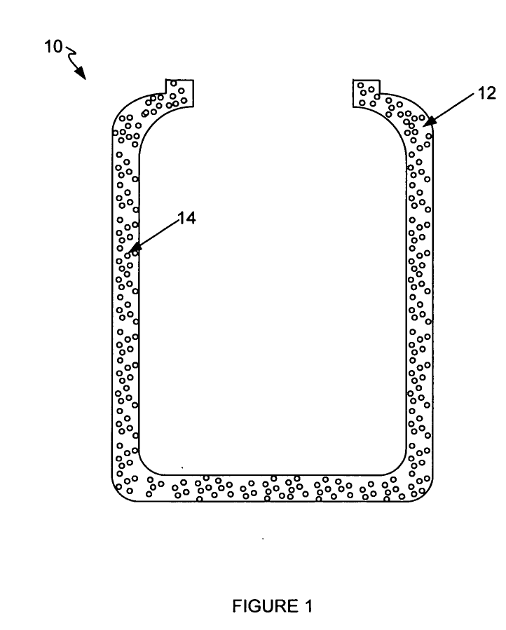

As shown in FIG. 1 there is a formed body 10 that includes at least one material 12 that includes a plurality of nanoparticles 14 that reflect and/or absorb UV radiation. Formed body 10 can be formed into any useful article. For example, formed body 10 can be formed into a container for holding at least one consumable product. The container may be, for example, chosen from medicine bottles, food containers, and beverage containers. The at least one consumable product may be chosen from medicine; food stuffs, such as meats, vegetables, food products, dairy products; beverages, such as fruit juices, soft drinks, wine, beer, milk, orange juice; pharmaceuticals; cosmetics; personal care products; shampoos; vitamins; inks; dyes; pigments; and the like.

In an embodiment, the at least one material 12 may be rigid or flexible mono- and/or multi-layered packaging materials. According to certain embodiments, the at least one material 12 may be chosen from any material suitable for containing a consumable product. For example, the material can be chosen from polymers, glass, metals, rubber, cardboard, fiberboard, paper, composites of any of the foregoing, and any material used to make a formed body known to one of ordinary skill in the art. For example, the at least one material 12 may be chosen from polypropylene (PP), polyethylene (PE), polycarbonate (PC), polyamides (PA), polyethylene terephthalate (PETE), polyvinylchloride (PVC); polystyrene (PS); polyesters, polyolefins, polyolefin copolymers such as ethylene-vinyl acetate, poly(vinylidene chloride), cellulosics, ethylene-vinyl alcohol, poly(vinyl alcohol), styrene-acrylonitrile and ionomers and mixtures or multi-layers of these polymers.

Typical multi-layer constructions have two or more layer laminates, manufactured either by thermoforming, or extrusion of multi-layer flexible films, or extrusion of bottle “preforms” or “parissons” followed by subsequent blow molding of the preforms into bottles.

For both films and rigid packaging (bottles), the exterior layer, and innermost layer contacting the contents, may be composed of polyesters such as PET or PEN (poly(ethylene)naphthalate), polypropylene, or polyethylene such as HDPE. The middle layers, often called “barrier” or “adhesive” or “tie” layers, may be composed of at least one combination of either PET, PEN, carboxylated polyethylene ionomer such as Surlyn®, vinyl alcohol homopolymers or copolymers such as poly(vinyl alcohol), partially hydrolyzed poly(vinyl acetate), poly(ethylene-co-vinyl alcohol) such as EVOH or EVAL, nylons or polyamides such as Selar® (DuPont) or polyamides based on metaxylenediamine (sometimes called nylon MXD-6), or polyvinylidene chloride (PVDC), or polyurethanes. For packaging of meats and vegetables, where a controlled rate of “respiration” or oxygen and moisture transport may be desired, polystyrenes and cellulosics may be used as the at least one material 12.

Where the at least one material is a multi-layer system, layers of any suitable plastic may be employed.

In accordance with the present disclosure, nanoparticles may control the coefficient of thermal expansion of a material making up a polymer. This enables the polymeric material to be less brittle, or to maintain its resiliency for a longer period of time than it would have without the nanoparticles.

The disclosed at least one material 12 may be useful in the manufacture of useful articles, such as containers or packages for comestibles such as beverages and food. The formed body of the disclosure may be a polymeric bottle, although other packages such as polymeric cartons and coatings for glass bottles may be used.

Rigid formed bodies may be manufactured by known mechanical processes: a) Single-stage blow molding such as performed on Nissei, Aoki, or Uniloy machines, b) Two-stage, injection molding of pre-forms such as on Netstal or Husky machines, and pre-forms converted to bottles by blow molding (e.g., on Sidel, Corpoplast and Krones machines), c) Integrated blow molding of pre-forms to bottles, such as processes conducted on Sipa, Krupp Kautex, or Husky ISB machines, and d) Stretch blow molding (SBM) of pre-forms to bottles.

The pre-forms may be mono-layer or multi-layer in construction. The bottles may optionally be post-treated to alter the inner wall properties. Bottles may optionally be surface treated on the exterior such as by application of surface coatings, such as the at least one material 12. The at least one material 12 can be a coating applied to a surface 16 of container 10.

In general, the plurality of nanoparticles used in the embodiments described herein can be produced using a variety of materials. For example, the materials used to make the plurality of nanoparicles can be single elements, such as the Group IV elements, metals or the rare earth elements. Alternatively, the materials can be nitrides, oxides, phosphides, carbides, sulfides, or selenides, or combinations thereof. In certain embodiments, the materials can be oxides including silicon oxide (SiOₓ), titanium dioxide (TiO₂), magnesium oxide (MgO), yttria (YtO), zircronia (ZrO₂), CeOₓ, alumina (Al₂O₃), lead oxide (PbOₓ), or composites of these oxides. In other embodiments, the materials can be made from III-V compounds or II-VI compounds. The materials can also include zinc selenide (ZnSe), zinc sulfide (ZnS), and alloys made from Zn, Se, S, Si, Fe, C, B, BN, and Te. Further, the materials can be gallium nitride (GaN), AlGaN, silicon nitride (Si₃N₄), SiN, or aluminum nitride. The material of the nanoparticles can also be metallic elements, such as, for example, Ag, Al, Au, Co, Cu, Fe, Mo, Ni, and W. The material of the nanoparticles can also be non-metallic elements such as, for example, Si and C, in any of its various forms (diamond, graphite, nanofibers, single and multi-walled nanotubes). These materials may be used individually or combined to form nanoparticles.

The plurality of nanoparticles used in the embodiments described herein may be substantially spherical. Alternatively, the shape of the plurality of nanoparticles may be non-spherical. For example, the shape of the plurality of nanoparticles may be faceted or may assume geometrical shapes such as cubes, pyramids, triangles, trapezoids, parallelograms, hexagons, tubes, or other shapes. However, the plurality of nanoparticles do not need to have the same shape.

The plurality of nanoparticles used in the embodiments described herein may be of various sizes. For example, the average size of the nanoparticles may be less than about each of the following: 1,000 nm, 700 nm, 500 nm, 100 nm, 75 nm, 50 nm, 25 nm, 15 nm, 10 nm, 5 nm, 2 nm, or 1 nm. The plurality of nanoparticles may be ⅕ of the wavelength of the radiation that is intended to be reflected and/or absorbed. Alternatively, the size of the plurality of nanoparticles may be in the range of 1/10 to 1/20 of the wavelength of the targeted radiation.

In certain embodiments, the plurality of nanoparticles may be included into the at least one material at a wt % of less than 50 wt % of the embodiments described herein. Alternatively, plurality of nanoparticles may be included into the at least one material at a wt % of less than 70 wt % of the embodiments described herein.

With the plurality of nanoparticles having the sizes described herein, the at least one material in which they may be incorporated remain transparent to visible light.

In other embodiments, the size of the plurality of nanoparticles may be controlled so that when the plurality of nanoparticles are incorporated into a particular material, the at least one material may prevent predetermined wavelengths of light from passing. The inclusion of the plurality of nanoparticles may render the material non-transmissive to the predetermined wavelengths of light. In certain embodiments the plurality of nanoparticles can be used to attenuate the passage of UV light through the material while simultaneously allowing the passage of visible light through the material.

In some embodiments, the plurality of nanoparticles may not be in physical contact with each other in a host material and may be prevented from agglomerating. Agglomeration is understood to be when two or more nanoparticles come into physical contact, such that the two nanoparticles effectively become one nanoparticle having a size of the combined two nanoparticles.

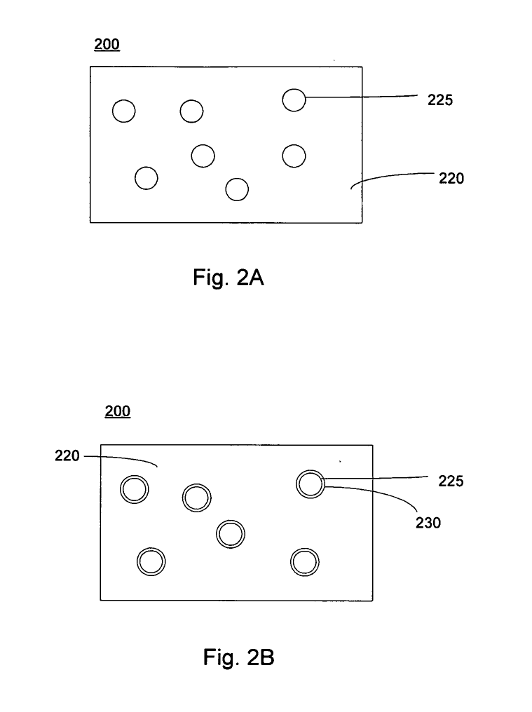

In certain embodiments, the plurality of nanoparticles may be separated from each other by the host material. For example, FIG. 2A shows an exemplary section 200 of a host material 210. Host material 210 will be described below. As seen in FIG. 2A, host material 210 includes a plurality of nanoparticles 215. In the exemplary section 200, plurality of nanoparticles 215 may be separated by host material 210.

In other embodiments, the plurality of nanoparticles may be prevented from agglomerating by coating the nanoparticles with a coating. As shown in FIG. 2B, there may be an exemplary section 200 of host material 210. As seen in FIG. 2B the host material 210 may include a plurality of nanoparticles 215 coated with a coating 220. The coating may prevent the plurality of nanoparticles from agglomerating or flocking together. In an embodiment, the anti-agglomeration coating may be a surfactant organic coating. Alternatively, the anti-agglomerative may be any other known organic coating with anti-agglomerative properties.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for slowing the degradation of a polymeric container, said method comprising forming the polymeric container from a composition comprising a plurality of nanoparticles dispersed therein.

2. The method according to claim 1, wherein the plurality of nanoparticles is selected from the group consisting of at least one of Group IV elements, metals, rare earth elements nitrides, oxides, phosphides, carbides, sulfides, selenides, metal oxides, II-V compounds, II-VI compounds, zinc selenide (ZnSe), zinc sulfide (ZnS), alloys made from Zn, Se, S, Si, Fe, C, B, BN, and Te; gallium nitride (GaN), AlGaN, silicon nitride (Si₃N₄), SiN, aluminum nitride, and non-metallic elements.

3. The method according to claim 2, wherein the metal oxides are selected from the group consisting of titanium dioxide (TiO₂), magnesium oxide (MgO), yttria (YtO), zircronia (ZrO₂), CeOₓ, alumina (Al₂O₃), lead oxide (PbOₓ), and composites of these oxides.

4. The method according to claim 2, wherein the metals are selected from the group consisting of Ag, Al, Au, Co, Cu, Fe, Mo, Ni, and W.

5. The method according to claim 2, wherein the non-metallic elements are selected from the group consisting of Si, B, and C.

6. The method according to claim 5, wherein the non-metallic element is C, and is in a form selected from the group consisting of diamond, graphite, nanofibers, single nanotubes, and multi-walled nanotubes.

7. A method for radiantly conducting ultraviolet radiation impinging upon a useful article, said method comprising forming the article from at least one material comprising a plurality of nanoparticles.

8. A method for attenuating the passage of ultraviolet radiation through a container designed to hold at least one consumable product, said method comprising forming the container from a composition comprising a plurality of nanoparticles.
